(19) United States
(12) Patent Application Publication
(10) Pub. No.: US 2010/0294644 A1
(43) Pub. Date: Nov. 25, 2010

(54) HEAT EXCHANGER

(75) Inventor: William H. Zebuhr, Nashua, NH (US)

Correspondence Address: FOLEY HOAG, LLP;PATENT GROUP, WORLD TRADE CENTER WEST, 155 SEAPORT BLVD, BOSTON, MA, 02110, US

(73) Assignee: ZanAqua Technologies, Hudson, NH (US)

(21) Appl. No.: 12/469,499

(22) Filed: May 20, 2009

(51) Int. Cl. F28D 7/00; F28F 9/007; F28D 7/10; B01D 3/00

(52) U.S. Cl. 202/177; 165/165; 165/67; 165/154

(57) ABSTRACT

A heat exchange system heats an influent liquid. The heat exchange system includes a plurality of heat exchanger modules arranged in a stacked configuration. Each of the heat exchanger modules includes a housing and three flow paths separated by heat transfer elements in the housing. Liquids flowing through two of the flow paths transfer heat through the heat transfer elements to influent liquid flowing through a flow path therebetween. The housing includes two opposed cover members on opposite sides of the heat transfer element and the flow paths. The heat exchange system also includes a support structure for supporting the plurality of heat exchanger modules. The support structure includes support elements engaging the cover members of the heat exchanger modules at opposite ends of the stacked configuration. Internal pressure on the cover members resulting from liquids in the flow paths is transferred to the support structure to inhibit outward deformation of the cover members.

### FIELD OF THE INVENTION

The present application generally relates to heat exchangers for heating influent liquids.

### BACKGROUND OF THE INVENTION

Distillation is the process of purifying a liquid (such as water) or, conversely, producing a concentrate (such as concentrated orange juice). In general, distillation involves heating liquid to be distilled to the point of evaporation, and collecting and condensing the resulting vapor.

U.S. Patent Application Publication No. 2008/0237025 discloses an example of a compact distiller. In such a distiller, the liquid to be distilled is heated to near its boiling temperature and then sprayed onto the heat-exchange surfaces of a rotary heat exchanger's evaporation chamber. A compressor draws the resultant vapor from the evaporation chamber, leaving contaminants behind. The compressor raises the vapor's pressure and delivers the higher-pressure vapor to the rotary heat exchanger's condensation chamber. In that chamber, thermal communication with the evaporation chamber results in the vapor condensing into a largely contaminant-free condensate, surrendering its heat of vaporization in the process to the liquid in the evaporation chamber. The distiller outputs the condensate as well as the concentrate remaining after the fluid has been evaporated.

The condensate and concentrate discharged from the distiller have a significantly higher temperature than the influent liquid entering the distiller. To improve energy efficiency, some distillation systems preheat the incoming influent liquid with heat recovered from the condensate and concentrate using a heat exchanger.

### BRIEF SUMMARY OF EMBODIMENTS OF THE INVENTION

One or more embodiments of the invention are directed to a heat exchange system that heats an influent liquid. The heat exchange system includes a plurality of heat exchanger modules that are arranged in a stacked configuration. Each of the heat exchanger modules includes a housing and three flow paths separated by a heat transfer elements in the housing. Liquids flowing through two of the flow paths transfer heat through the heat transfer elements to influent liquid flowing through a flow path therebetween. The housing includes two opposed cover members on opposite sides of the heat transfer element and the flow paths. The heat exchange system also includes a support structure for supporting the plurality of heat exchanger modules. The support structure includes support elements engaging the cover members of the heat exchanger modules at opposite ends of the stacked configuration. Internal pressure on the cover members resulting from the liquids in the flow paths is transferred to the support structure to inhibit outward deformation of the cover members.

One or more embodiments of the invention are directed to a distillation system that includes a distiller and a heat exchange system. The distiller distills an influent liquid and produces a condensate and a concentrate. The heat exchange system is coupled to the distiller for pre-heating the influent liquid entering the distiller. The heat exchange system includes a plurality of heat exchanger modules arranged in a stacked configuration. Each of the heat exchanger modules includes a housing and two flow paths separated by a heat transfer element in the housing. The condensate or concentrate from the distiller flows through one of the flow paths and transfers heat through the heat transfer element to influent liquid flowing through the other flow path. The housing includes two cover members on opposite sides of the heat transfer element and the flow paths. The heat exchange system also includes a support structure for supporting the plurality of heat exchanger modules. The support structure includes support elements engaging the cover members of the heat exchanger modules at opposite ends of the stacked configuration. Internal pressure on the cover members resulting from the liquids in the flow paths is transferred to the support structure to inhibit outward deformation of the cover members.

One or more embodiments of the invention are directed to a heat exchange system for heating an influent liquid. The heat exchange system includes a heat exchanger module and a support structure for supporting the heat exchanger module. The heat exchanger module includes a housing and two flow paths separated by a heat transfer element in the housing. Liquid flowing through one of the flow paths transfers heat through the heat transfer element to the influent liquid flowing through the other flow path. The housing includes two opposed cover members on opposite sides of the heat transfer element and the flow paths. The support structure includes support elements engaging the cover members at opposite sides of the heat exchanger module. Internal pressure on the cover members resulting from the liquids in the flow paths is transferred to the support structure to inhibit outward deformation of the cover members.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIGS. 1A and 1B are front and rear views, respectively, of the exterior of a distillation unit in accordance with one or more embodiments of the invention.

FIG. 2 is a simplified cross-section view of the distillation unit.

FIG. 3 is a simplified block diagram illustrating fluid flow through a counterflow heat exchange system in accordance with one or more embodiments of the invention.

FIG. 4 is a perspective view of the heat exchanger module in accordance with one or more embodiments of the invention.

FIG. 5 is an exploded view of the heat exchanger module.

FIG. 6 is a cross-section view a portion of the heat exchanger module taken generally along line z-z of FIG. 4.

FIG. 7 is a front perspective view of a heat exchange system in accordance with one or more embodiments of the invention.

FIG. 8 is a rear perspective view of the heat exchange system.

FIG. 9 is a top view of the heat exchange system.

FIG. 10 is a front view of the heat exchange system.

FIG. 11 is a cross-section view of the heat exchange system taken generally along line x-x of FIG. 10.

FIG. 12 is an exploded view of the heat exchange system.

### DETAILED DESCRIPTION

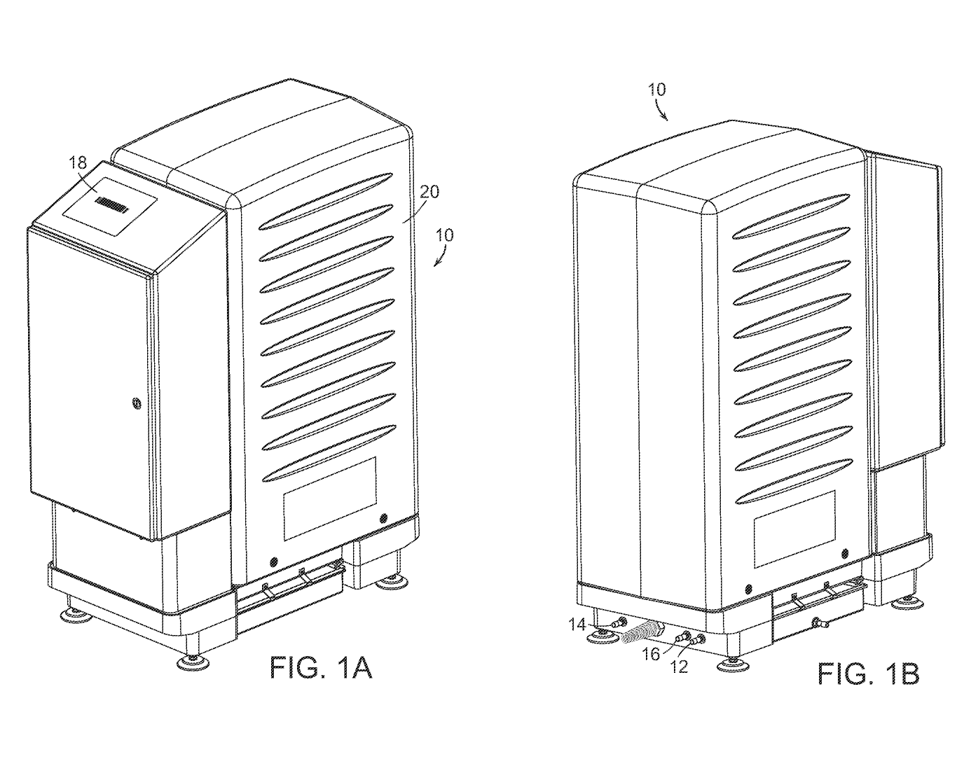

FIGS. 1A and 1B are exterior views of an exemplary distillation unit or system 10 having a counterflow heat exchange system in accordance with various embodiments of the invention. The distillation unit 10 includes a feed inlet 12 through which the unit 10 receives an influent liquid to be distilled. The distillation unit 10 can be used for various distillation purposes, such as purifying water or condensing liquids like orange juice. For the sake of simplicity, in the exemplary embodiments described herein, the purpose is assumed to be water purification, and the influent liquid is accordingly water that contains contaminants to be removed.

The unit 10 purifies the influent liquid, producing a generally pure condensate at a condensate outlet 14. The volume rate at which condensate is produced at the outlet 14 will generally be slightly less than the rate at which influent liquid enters inlet 12, with nearly all the remainder being a small stream of concentrated impurities discharged through a concentrate outlet 16. For example, in many cases, the condensate volume flow rate is about 80% to 95% of the influent liquid flow rate, with the concentrate volume flow rate accounting for the remainder.

The distillation unit 10 includes a control unit 18 including a programmable logic controller for controlling operation of the unit 10. A control panel with a keypad and display can be used by an operator to monitor and control operation of the unit 10.

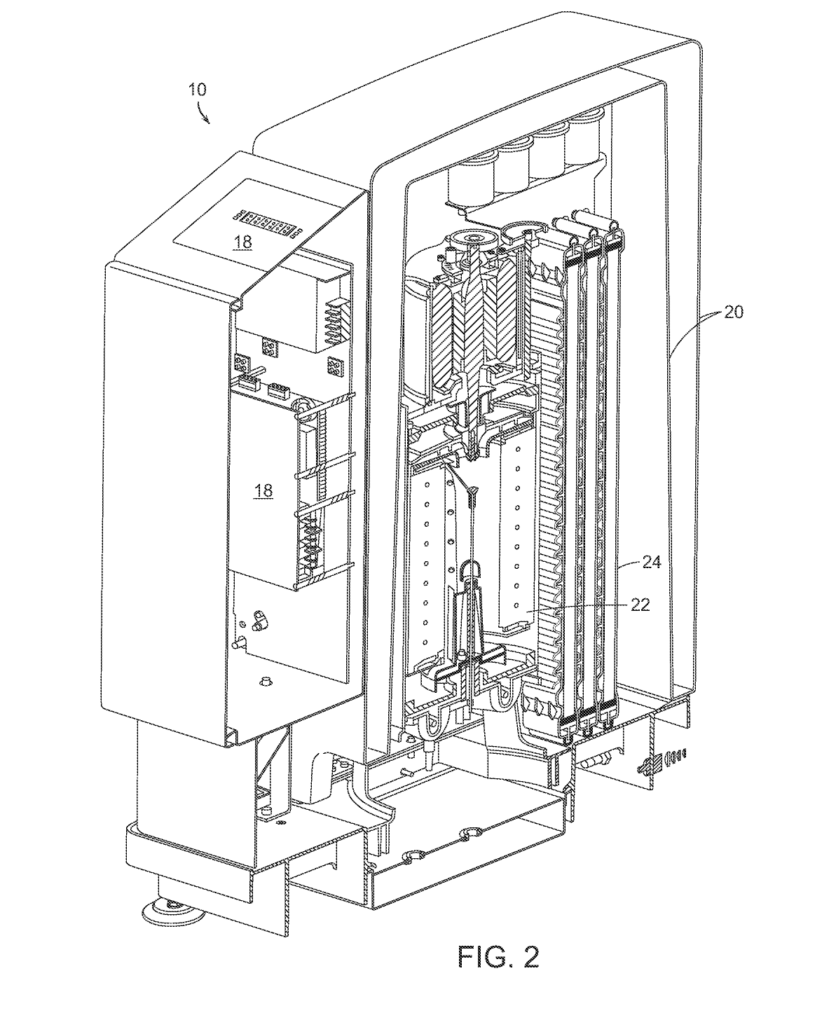

FIG. 2 is a simplified cross-section view of the distillation unit 10. The distillation unit 10 includes a housing 20 having an insulated wall made of a low-thermal-conductivity material such as polyurethane. The distillation unit 10 includes a distiller 22 and a counterflow heat exchange system 24 located within the housing 20. The counterflow heat exchange system 24 allows heat from the condensate and concentrate fluids exiting the distiller 22 to be largely recovered and transferred to the influent liquid entering the unit 10 at the feed inlet 12.

A feed-water pump, which is not shown in the figures, can be outside the distillation unit 10, drives influent liquid from the feed inlet 12 through the counterflow heat exchange system 24. After being heated by the counterflow heat exchange system 24, the influent liquid flows to the distiller 22. In the exemplary embodiment, the distiller 22 includes a rotary heat exchanger, and the influent liquid, after being heated, is sprayed onto the exterior surfaces of the radially extending heat-transfer blades of a rotary heat exchanger forming an evaporation chamber. The sprayed water absorbs heat and partially evaporates in the evaporation chamber, leaving unevaporated impurities behind. A compressor draws in the resulting vapor and feeds it pressurized into an interior condensation chamber defined by the interior surfaces of the hollow heat transfer blades. There, the pressurized water vapor condenses, surrendering its heat of vaporization through the blade walls to the water sprayed on the blades' exterior surfaces.

The condensate is the purified output of the distiller 22. The distiller 22 also outputs the concentrate that remains after the influent liquid has been evaporated. The counterflow heat exchange system 24 receives condensate and the concentrate (which can have a temperature of about 212° F.) from the distiller 22, cools them by thermal communication with the incoming influent liquid (which can have an initial temperature of about 70° F.), and delivers them to the respective condensate and concentrate outlets 14, 16 shown in FIG. 1B (at a temperature of about 77° F). In the exemplary embodiment, the influent liquid can be heated by the heat exchange system 24 to a temperature of about 200 to 205° F.

While a rotary heat exchanger type distiller 22 is described above and illustrated by the figures herein, it should be understood that the counterflow heat exchange system 24 is not limited to use with such distillers, but can be used to preheat the influent liquid for any type of distiller.

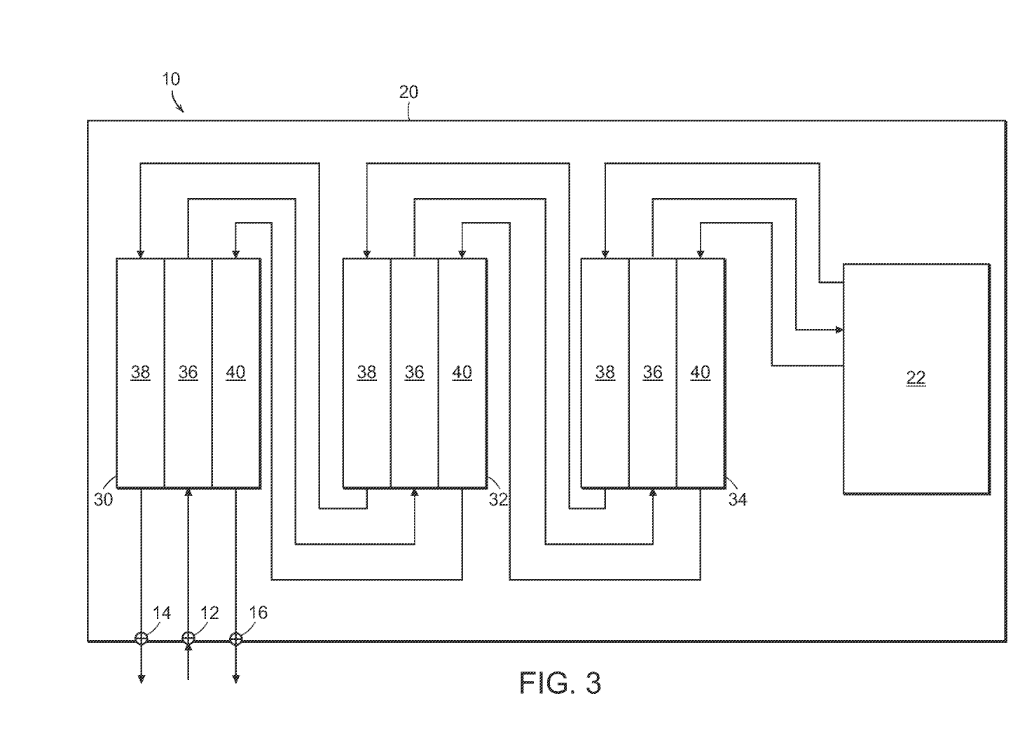

FIG. 3 is a simplified block diagram illustrating liquid flow through the counterflow heat exchange system 24. The counterflow heat exchange system 24 includes a plurality of heat exchanger modules 30, 32, 34, which can be substantially identical and are connected in series. In the exemplary embodiment, three heat exchanger modules 30, 32, 34 are shown. It should be understood that any number of heat exchanger modules can be used as desired to control the amount of heat recovered. Space constraints and a diminishing rate of return after a given number of modules can be considerations for selecting the number modules.

The heat exchanger modules 30, 32, 34 in the exemplary embodiment are coupled for serial flow of liquid therethrough. (It should be understood, however, that the heat exchanger modules can alternately be connected in parallel or have some combination of series and parallel connections.) The influent liquid flows from the feed inlet 12 through the first heat exchanger module 30, the second heat exchanger module 32, and then the third heat exchanger module 34 before entering the distiller 22. The concentrate and condensate flow in an opposite direction to the influent liquid, i.e., from the distiller 22 through the third heat exchanger module 34, the second heat exchanger module 32, and then the first heat exchanger module 30 before being discharged through respective concentrate and condensate outlets 14, 16.

Each of the heat exchanger modules 30, 32, 34 includes an influent liquid inlet, an influent liquid outlet, a condensate inlet, a condensate outlet, a concentrate inlet, and a concentrate outlet. The influent liquid inlet of the first heat exchanger module 30 receives influent liquid from the feed inlet 12. The influent liquid outlet of the first heat exchanger module 30 is coupled to the influent liquid inlet of the second heat exchanger module 32, and the influent liquid outlet of the second heat exchanger module 32 is coupled to the influent liquid inlet of the third heat exchanger module 34. The influent outlet of the third heat exchanger module 34 is coupled to the distiller 22.

The condensate inlet of the third heat exchanger modules 34 receives condensate from the distiller 22. The condensate outlet of the third heat exchanger module 34 is coupled to the condensate inlet of the second heat exchanger module 32, and the condensate outlet of the second heat exchanger module 32 is coupled to the condensate inlet of the first heat exchanger module 30. Condensate from the condensate outlet of the first heat exchanger module 30 flows to the condensate outlet 14 of the distillation unit 10.

Similarly, the concentrate inlet of the third heat exchanger modules 34 receives concentrate from the distiller 22. The concentrate outlet of the third heat exchanger module 34 is coupled to the concentrate inlet of the second heat exchanger module 32, and the concentrate outlet of the second heat exchanger module 32 is coupled to the concentrate inlet of the first heat exchanger module 30. Concentrate from the concentrate outlet of the first heat exchanger module 30 flows to the concentrate outlet 16 of the distillation unit 10.

The feed water pump drives influent liquid from the influent liquid inlet 12 serially through an influent flow path 36 in each of the first, second, and third heat exchanger modules 30, 32, 34. Condensate and concentrate outputs of the distiller 22 are drawn by respective pumps from the distiller 22 and driven serially through separate respective flow paths 38, 40 in the third, second, and finally first heat exchanger modules 34, 32, 30.

While flowing through each of the three heat exchanger modules 30, 32, 34, the influent liquid is in thermal communication across heat transfer surfaces with a counterflow of the condensate and concentrate flowing through respective flow paths in the heat exchanger modules 30, 32, 34. The influent liquid is progressively heated as it flows successively through the heat exchanger modules 30, 32, 34.

Although not shown, a series of vents can be provided (one after each heat exchanger module) for degassing the influent liquid.

The heat exchanger modules 30, 32, 34 are preferably oriented in the unit 10 such that the flow paths therethrough are vertical, and that the influent liquid flows in an upward direction through each of the modules. An upward flow of the influent liquid helps avoid the entrapment of gas bubbles, which can reduce the heat transfer rate.

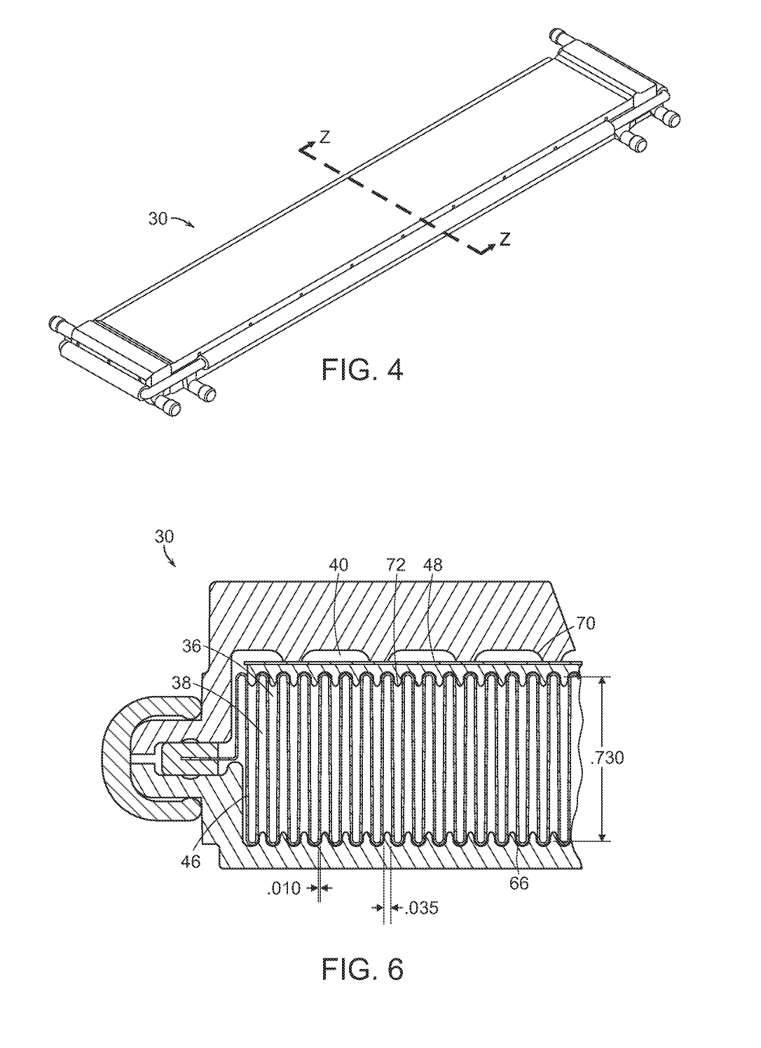

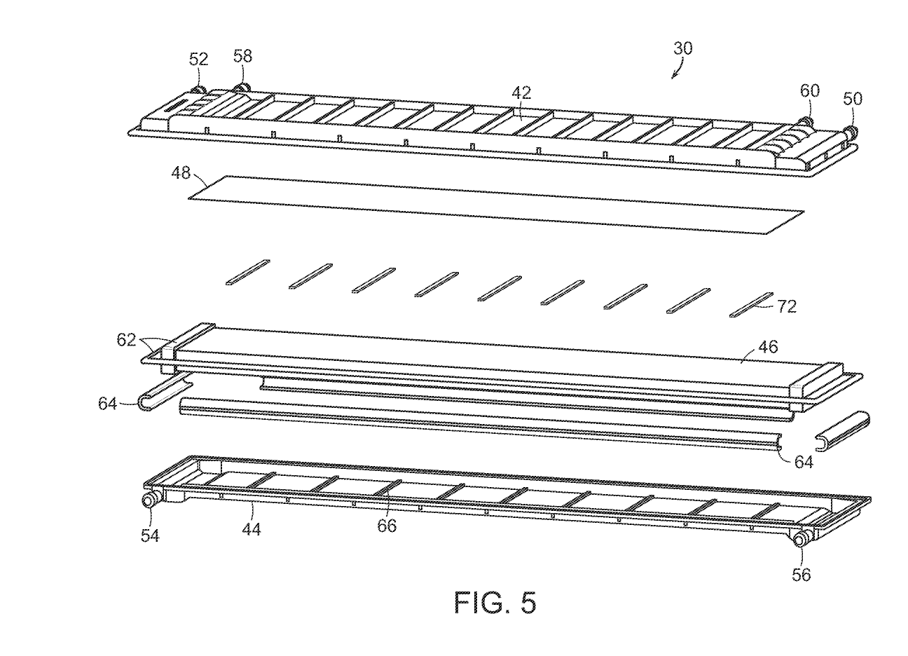

FIGS. 4-6 illustrate one of the exemplary heat exchanger modules 30, 32, 34 shown in perspective, exploded, and cross-sectional views, respectively. The heat exchanger module 30 includes first and second cover members 42, 44, which are joined together to form an outer housing for the heat exchanger module 30. The housing encloses a corrugated foil member 46, which separates (and acts as a heat transfer surface between) the influent liquid and the condensate. The heat exchanger module 30 also includes a concentrate foil member 48, which separates (and acts as a heat transfer surface between) the influent liquid and the concentrate.

Influent liquid enters the heat exchanger module 30 at influent liquid inlet 50, passes through an influent flow path 36, and exits the heat exchanger module at influent liquid outlet 52. The influent flow path 36 is defined by one side of the corrugated foil member 46 and the concentrate foil member 48.

The condensate enters the heat exchanger module at condensate inlet 54, passes through a condensate flow path 38, and exits the heat exchanger module at a condensate outlet 56. The condensate flow path 38 is defined by the inside of the second cover member 44 and the side of the corrugated foil member 46 opposite to the influent flow path 36.

The concentrate enters the heat exchanger module at concentrate inlet 58, passes through a concentrate flow path 40, and exits the heat exchanger module at a concentrate outlet 60. The concentrate flow path 40 is defined by the concentrate foil member 48 and the inside of the first cover member 42.

The condensate flow path 38 and the concentrate flow path 40 are thereby on opposite sides of the influent flow path 36. In the exemplary embodiment, the condensate and the concentrate flow in an opposite direction to the influent liquid, and the heat exchanger module is accordingly a counterflow heat exchanger. In an alternative embodiment, the condensate and concentrate can flow in the same direction as the influent liquid, and the heat exchanger module is accordingly a parallel flow heat exchanger.

In the exemplary embodiment, both the condensate and concentrate are used to heat the influent liquid. In an alternative embodiment, only one of the concentrate and condensate is used to heat the influent liquid.

As previously discussed, the influent liquid and condensate typically have approximately the same volume flow rate and their flow paths accordingly have a generally equal cross sectional area. The concentrate typically has lower volume flow rate than the influent liquid and accordingly has a proportionally smaller cross sectional area in order to maintain thermal balance.

The exemplary heat exchanger module is approximately 24 inches tall, 4 inches wide, and 1 inch thick. The size of the heat exchanger module can be varied based on the heat transfer surface areas desired and the available space within the distillation system.

Most of the heat transfer in the heat exchanger module 30 occurs through the corrugated foil member heat transfer surface 46 separating the condensate and the influent liquid. The corrugated foil member 46 can be made from a thermally conductive sheet metal. In the exemplary embodiment, the thickness of the metal is about 0.010 inches. This thickness can be varied. For example, it may be increased to improve structural rigidity (though this may decrease the heat transfer rate). The material can be a stainless steel or any corrosion resistant material with high thermal conductivity, such as copper nickel alloys. In the exemplary embodiment, each of the corrugations forming the flow paths in the corrugated foil member 46 has a width of about 0.035 inches and a height of about 0.730 inches. The manufacturing tolerances of the corrugations dimensions are preferably not greater than 0.005 inches. Corrugations with significant size differences may cause the influent liquid to flow at a different rate than the condensate, reducing the heat transfer efficiency. Having a fluid flow path or corrugation width of about 0.035 inches allows a relatively large heat transfer surface area to be contained in a small volume, and creates a high heat transfer coefficient. The width of the flow path is preferably selected to be small enough to allow for high heat transfer rate, but large enough to avoid fluid drag.

To provide a perimeter face seal 62, the corrugated foil member 46 is preferably overmolded with rubber (e.g., EPDM, Viton, Silicone, or other). The first and second cover members 42, 44 are clamped together with clamps 64 to complete the seal.

The second cover member 44 is only exposed to condensate flow and can be made of a suitable thermoplastic or thermoset plastic. The thickness of the cover member 44 can vary depending on the material used and it is not pertinent to thermal performance. The cover member 44 has a plurality of spacer combs 66 molded on its inside surface. The spacer combs 66, which are spaced-apart along the length of the cover member 44, have teeth that fit within alternate folds of the corrugations in the corrugated foil 46 and help to maintain the spacing of the corrugations. The spacer combs 66 help keep the foil 46 from changing shape if, e.g., the influent liquid and concentrate flows have significantly different pressures during use.

The clamps 64 can be, e.g., extruded aluminum parts. They are generally C-shaped in cross section and provide an interference fit over projecting edges of the cover members 42, 44 such that a generally continuous pressure is maintained on the seal at all times independent of changing internal pressure and temperature. Four clamps 64 are used, one at each side, around the perimeter of the heat exchanger. Clamps are preferably used instead of fasteners such as screws to decrease assembly time and to maintain more even clamping pressure.

The first cover member 42 is exposed to both influent liquid and concentrate, and is preferably made of a material that is suitable for exposure to potential contaminants in the influent liquid and concentrate. The cover member 42 can be made from, e.g., a thermoset plastic or liquid crystal polymer thermoplastic. The cover member 42 includes a chamber molded therein to form one side of the concentrate flow path 40. The other side of the concentrate path 40 is defined by the concentrate foil 48, which separates the concentrate from the influent liquid. The concentrate foil 48 can be, e.g., 0.008″ thick and can be made from a corrosion resistant metal or alloy with high thermal conductivity such as stainless steel or copper nickel. The cover member 42 has molded therein a plurality of spacers in the form of dimples 70 that support the concentrate foil 48 to maintain a generally constant separation between the cover member 42 and the concentrate foil 48 through the length of the heat exchanger module 30.

The heat exchanger module 30 also includes a plurality of spacer combs 72 positioned at spaced-apart locations between the concentrate foil 48 and the corrugated foil 46. Dimples 70 in contact with the opposite side of the concentrate foil 48 are aligned with the spacer combs 72. The spacer combs 72 help separate the concentrate foil 48 and the corrugated foil 46 to create space for the influent liquid to flow across concentrate foil 48. In addition, the spacer combs 72 have teeth that fit within alternate folds of the corrugations in the corrugate foil to help maintain proper spacing in a similar manner to the spacer combs 66 of cover member 44. The concentrate foil 48 can be sealed to the cover member 42 using a gasket, which can be, e.g., a solid rubber gasket or a liquid applied gasket such as silicone RTV.

The exemplary heat transfer module provides improved heat recovery with reduced part count, part complexity, cost, and assembly time.

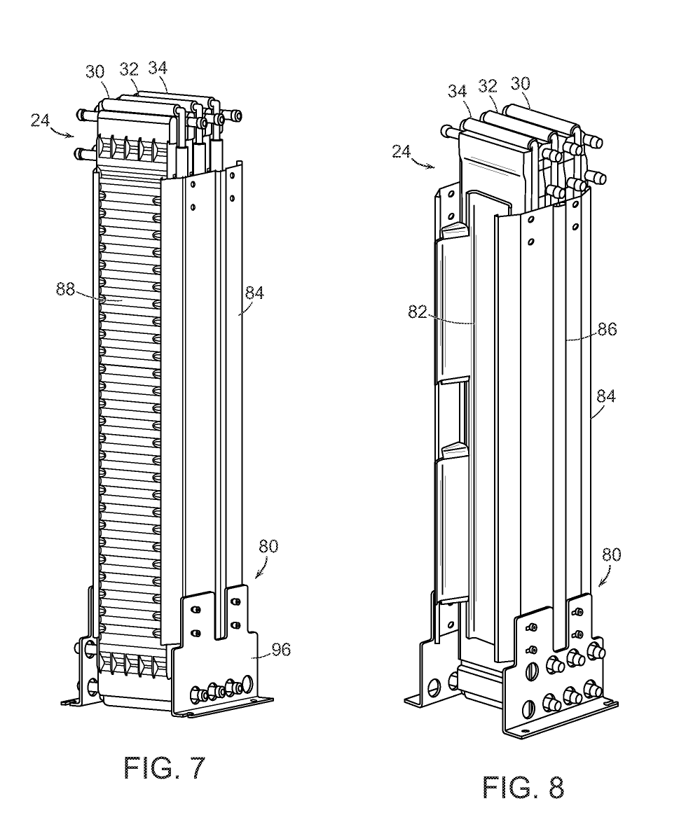

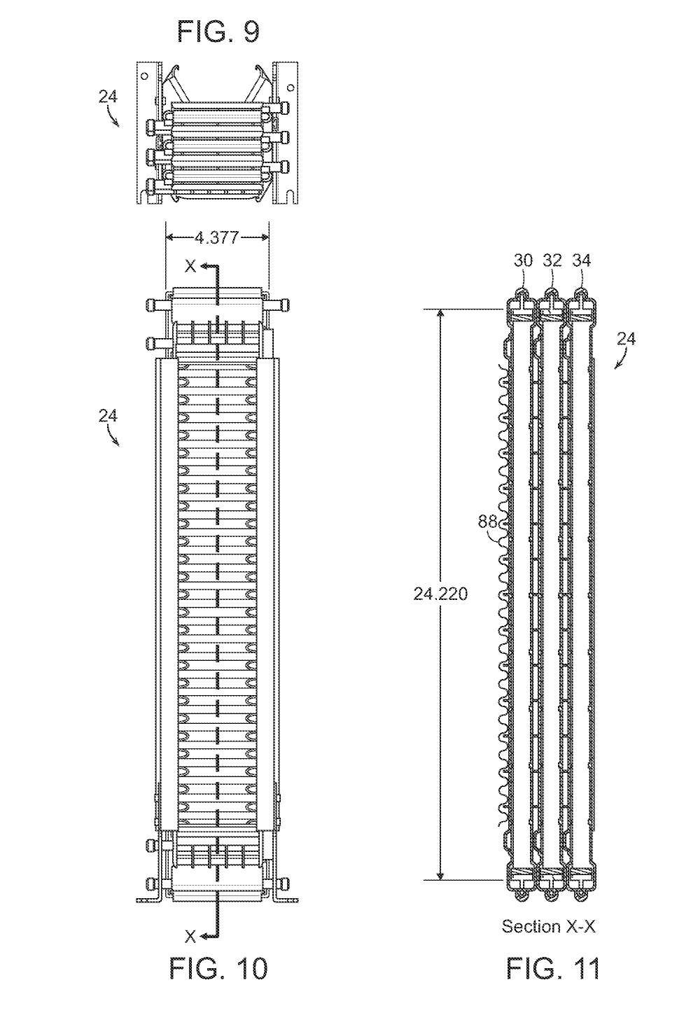

FIGS. 7-12 illustrate an exemplary heat exchange system 24 in accordance with various embodiments of the invention. The heat exchange system 24 includes a plurality of heat exchanger modules 30, 32, 34 (as previously described), which are bundled and held in a metallic exoskeleton or support structure 80. FIGS. 7 and 8 are front and rear perspective views, respectively, of the heat exchange structure 80. FIGS. 9, 10, 11, and 12 are top, front, cross-section, and exploded views, respectively, of the heat exchange system 24.

The exemplary heat exchange system 24 illustrated in the drawings is designed to hold up to four heat exchanger modules, but is shown with only three modules 30, 32, 34. A removable spacer member 82 occupies space in the structure in place of a possible fourth heat exchanger module at the rear side of structure.

The support structure 80 provides a generally rigid frame to support the bundle of heat exchanger modules 30, 32, 34 from the internal pressure load resulting from fluid flow through the heat exchanger modules 30, 32, 34. Transferring the pressure load from the heat exchanger modules 30, 32, 34 to the outer support structure 80 allows for the use of low cost plastics covers for the heat exchanger modules 30, 32, 34 instead of metals or other strengthened materials, thereby reducing cost and weight.

The support structure 80 includes four sheet metal side panels 84, two on each side of the bundle for compressing the bundle and holding it together. The side panels 84 can be made from sheet metal such as aluminum or stainless steel. Two clamps 86 are used to hold the side panels 84 together. The clamps 86 can comprise extruded aluminum, and can be slid into place on the side panels 84.

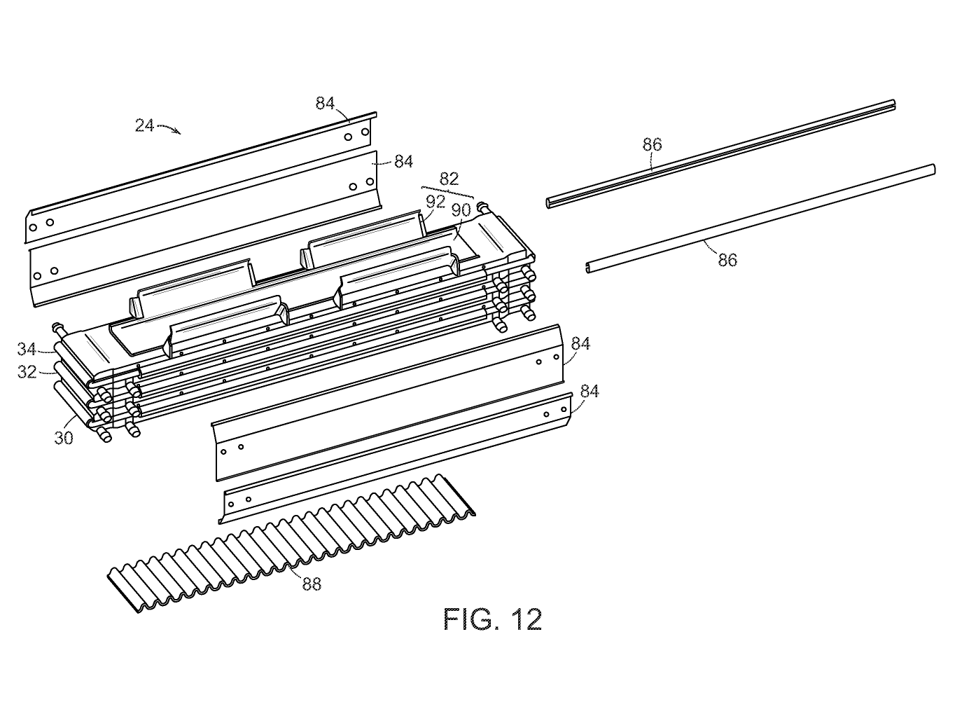

The support structure 80 also includes one or two corrugated sheet metal support members 88 to support the front and rear sides of the bundle. One or both of the corrugated sheet metal support members 88 can be replaced by a spacer member 82 (as shown in FIGS. 8 and 12) if a spacer is needed in the structure. The spacer member 82 is used to properly position and support the heat exchanger modules 30, 32, 34 in place in the support structure 80 when fewer modules are used than the support structure 80 is designed to hold. The spacer member 82 includes a support plate 90 to engage a cover 42, 44 of a heat exchanger module and projections 92 extending from the support plate 90 to engage the side panels 84. In the illustrated heat exchange structure, if a fourth heat exchanger module were to be used, the spacer member 82 would be replaced by a second corrugated sheet metal support member 88.

The support structure 80 is assembled by arranging the heat exchanger modules 30, 32, 34 in the stack, and placing the corrugated sheet metal support member 88, spacer member 82, and side panels 84 in place around the stack. The extruded clamp 86 is then slid into place on the side panels 84. The side panels 84 are thereby put in tension, and the spacer member 82 and corrugated support member 88 are compressed acting as springs holding the bundle together. As a final assembly step the brackets 96 are installed onto the side panels 84 for forming a base that can be mounted in the distillation unit 10.

If the heat exchanger modules 30, 32, 34 were not bundled and supported by the support structure 80, each heat exchanger would need to be significantly more rigid to withstand the internal pressure resulting from fluid flow through the modules. During operation, forces from fluids flowing through the flow paths on the cover members 42, 44 can cause the cover members 42, 44 to deform outwardly. This can result in reduced heat transfer efficiencies (since less fluid will flow across the heat transfer surfaces) and may lead to fluid leakage. The bundling of the heat exchanger modules 30, 32, 34 as illustrated inhibits deformation of the cover members 42, 44 since the cover members 42, 44 are in contact with and supported by cover members 42, 44 of adjacent modules within the stack, or by the spacer member 82 or corrugated support member 88 from the support structure 80 at the opposite ends of the stack. Internal fluid pressures acting on the cover members 42, 44 of the heat exchanger modules 30, 32, 34 are thereby transferred to the support structure 80.

In the exemplary embodiment, the corrugated sheet metal support member 88 is made from a sheet of aluminum having a thickness of about 0.020 to 0.040 inches. Alternately, the corrugated sheet metal support member 88 could be made of a thinner sheet of stainless steel having a thickness of about 0.010 to 0.020 inches. In the exemplary embodiment, the corrugated sheet metal support member 88 has a height of about 0.38 inches, a pitch of about 0.75 inches, a width of about 3.5 inches, and a length of about 19.5 inches.

In the exemplary embodiment, the spacer member 82 includes a support plate 90 made from a sheet of aluminum having a thickness of about 0.080 to 0.100 inches. Alternately, the support plate 90 could be made of a thinner sheet of stainless steel having a thickness of about 0.020 to 0.030 inches.

It is to be understood that although the invention has been described above in terms of particular embodiments, the foregoing embodiments are provided as illustrative only, and do not limit or define the scope of the invention. Various other embodiments are also within the scope of the claims. For example, elements and components described herein may be further divided into additional components or joined together to form fewer components for performing the same functions.

1. A heat exchange system for heating an influent liquid, comprising:
a plurality of heat exchanger modules arranged in a stacked configuration, each of the heat exchanger modules comprising a housing and two flow paths separated by a heat transfer element in the housing, wherein a liquid flowing through one of the flow paths transfers heat through the heat transfer element to the influent liquid flowing through the other flow path, and wherein the housing includes two opposed cover members on opposite sides of the heat transfer element and the flow paths; and
a support structure for supporting the plurality of heat exchanger modules, the support structure including support elements engaging the cover members of the heat exchanger modules at opposite ends of the stacked configuration, wherein internal pressure on the cover members resulting from the liquids in the flow paths is transferred to the support structure to inhibit outward deformation of the cover members.

2. The heat exchange system of claim 1, wherein at least one of the support elements of the support structure comprises a corrugated metal support member substantially covering a cover member.

3. The heat exchange system of claim 2, wherein the corrugated metal support member is formed from a sheet of aluminum, copper, or stainless steel.

4. The heat exchange system of claim 1, wherein the support structure is configured for holding a greater number of heat exchanger modules than the plurality of heat exchanger modules, and wherein at least one of the support elements of the support structure comprises a spacer for supporting and properly positioning the plurality of heat exchanger modules relative to the support structure.

5. The heat exchange system of claim 1, wherein the support structure further comprises a base and side panels extending from the base, wherein the support elements are engaged by the side panels to compress the stacked configuration of heat exchanger modules.

6. The heat exchange system of claim 5, wherein the support structure further comprises a clamp for connecting side panels at opposite sides of the stacked configuration of heat exchanger modules.

7. The heat exchange system of claim 1, wherein each of the heat exchanger modules includes a second heat transfer element defining an additional flow path for flow therethrough of another liquid to heat the influent liquid.

8. The heat exchange system of claim 7, wherein the liquid and said another liquid are received from a distiller and comprise a condensate and a concentrate, respectively.

9. The heat exchange system of claim 1, wherein the cover members comprise plastic.

10. The heat exchange system of claim 1, wherein the heat exchanger modules each comprise a counterflow heat exchanger.

11. The heat exchange system of claim 1, wherein the flow paths of the heat exchanger modules are vertically oriented and the heat exchanger modules are serially coupled such that the influent liquid flows in an upward direction through each heat exchanger module.

12. The heat exchange system of claim 1, wherein the heat exchanger modules are coupled in series, in parallel, or some combination thereof.

13. A distillation system, comprising:
a distiller for distilling an influent liquid and producing a condensate and a concentrate; and
a heat exchange system coupled to the distiller for pre-heating the influent liquid entering the distiller; the heat exchange system comprising:
(a) a plurality of heat exchanger modules arranged in a stacked configuration, each of the heat exchanger modules comprising a housing and two flow paths separated by a heat transfer element in the housing, wherein the condensate or concentrate from the distiller flowing through one of the flow paths transfers heat through the heat transfer element to influent liquid flowing through the other flow path, and wherein the housing includes two cover members on opposite sides of the heat transfer element and the flow paths; and
(b) a support structure for supporting the plurality of heat exchanger modules, the support structure including support elements engaging the cover members of the heat exchanger modules at opposite ends of the stacked configuration, wherein internal pressure on the cover members resulting from the liquids in the flow paths is transferred to the support structure to inhibit outward deformation of the cover members.

14. The distillation system of claim 13, wherein at least one of the support elements of the support structure comprises a corrugated metal support member substantially covering a cover member.

15. The distillation system of claim 14, wherein the corrugated metal support member is formed from a sheet of aluminum, copper, or stainless steel.

16. The distillation system of claim 13, wherein the support structure is configured for holding a greater number of heat exchanger modules than the plurality of heat exchanger modules, and wherein at least one of the support elements of the support structure comprises a spacer for supporting and properly positioning the plurality of heat exchanger modules relative to the support structure.

17. The distillation system of claim 13, wherein the support structure further comprises a base and side panels extending from the base, wherein the support elements are engaged by the side panels to compress the stacked configuration of heat transfer modules.

18. The distillation system of claim 17, wherein the support structure further comprises a clamp for connecting side panels at opposite sides of the stacked configuration of heat transfer modules.

19. The distillation system of claim 13, wherein each of the heat exchanger modules includes a second heat transfer element defining an additional flow path for flow therethrough of another liquid from the distiller to heat the influent liquid.

20. The distillation system of claim 13, wherein the cover members comprise plastic.

21. The distillation system of claim 13, wherein the heat exchanger modules each comprise a counterflow heat exchanger.

22. The distillation system of claim 13, wherein the flow paths of the heat exchanger modules are vertically oriented and the heat exchanger modules are serially coupled such that the influent liquid flows in an upward direction through each heat exchanger module.

23. The distillation system of claim 13, wherein the heat exchanger modules are coupled in series, in parallel, or some combination thereof.

24. A heat exchange system for heating an influent liquid, comprising:
a heat exchanger module including a housing and two flow paths separated by a heat transfer element in the housing, wherein a liquid flowing through one of the flow paths transfers heat through the heat transfer element to the influent liquid flowing through the other flow path, and wherein the housing includes two opposed cover members on opposite sides of the heat transfer element and the flow paths; and
a support structure for supporting the heat exchanger module, the support structure including support elements engaging the cover members of the heat exchanger module at opposite sides of the heat exchanger module, wherein internal pressure on the cover members resulting from the liquids in the flow paths is transferred to the support structure to inhibit outward deformation of the cover members.

25. The heat exchange system of claim 24, wherein at least one of the support elements of the support structure comprises a corrugated metal support member substantially covering a cover member.

26. The heat exchange system of claim 25, wherein the corrugated metal support member is formed from a sheet of aluminum, copper, or stainless steel.

27. The heat exchange system of claim 24, wherein the support structure is configured for holding a plurality of heat exchanger modules, and wherein at least one of the support elements of the support structure comprises a spacer for supporting and properly positioning the heat exchanger module relative to the support structure.

28. The heat exchange system of claim 24, wherein the support structure further comprises a base and side panels extending from the base, wherein the support elements are engaged by the side panels to compress the heat exchanger module.

29. The heat exchange system of claim 28, wherein the support structure further comprises a clamp for connecting side panels at opposite sides of the heat exchanger module.

30. The heat exchange system of claim 24, wherein the heat exchanger module includes a second heat transfer element defining an additional flow path for flow therethrough of another liquid to heat the influent liquid.

31. The heat exchange system of claim 30, wherein the liquid and said another liquid are received from a distiller and comprise a condensate and a concentrate, respectively.

32. The heat exchange system of claim 24, wherein the cover members comprise plastic.

33. The heat exchange system of claim 24, wherein the heat exchanger module comprises a counterflow heat exchanger.

34. The heat exchange system of claim 24, wherein the flow paths of the heat exchanger module are vertically oriented and the influent liquid flows in an upward direction through the heat exchanger module.
